(19) United States
(12) Patent Application Publication
(10) Pub. No.: US 2015/0006369 A1
(43) Pub. Date: Jan. 1, 2015

(54) METHOD FOR INTERNET-BASED COMMERCIAL TRADE IN COLLABORATIVELY CREATED SECONDARY DIGITAL MEDIA PROGRAMS

(71) Applicant: LITTLE ENGINES GROUP, INC., TOPANGA, CA (US)

(72) Inventor: HOWARD DAVID SOROKA, TOPANGA, CA (US)

(21) Appl. No.: 14/315,165

(22) Filed: Jun. 25, 2014

Related U.S. Application Data
(60) Provisional application No. 61/840,405, filed on Jun. 27, 2013.

(51) Int. Cl. G06Q 10/10; G06Q 50/18

(52) U.S. Cl. CPC G06Q 10/101; G06Q 50/184
USPC 705/39; 705/300

(57) ABSTRACT

There is disclosed an apparatus and method for internet-based commercial trade in collaboratively created secondary digital media programs The method comprises accessing data comprising a primary program generated using an authoring tool, enabling acceptance of a channel of a secondary program, each channel of the secondary program comprising a set of rich metadata associated with the primary program, from a user of the primary program other than the original creator of the primary program and storing the channel in association with the primary program in a database of rich metadata for access by other users of the primary program. The method further comprises enabling access, upon request, to the channel in association with the primary program via a playback tool.

### RELATED APPLICATION INFORMATION

This patent claims priority from provisional patent application 61/840,405 filed Jun. 27, 2013 titled “BUSINESS METHOD FOR INTERNET-BASED COMMERCIAL TRADE IN COLLABORATIVELY CREATED SECONDARY DIGITAL MEDIA PROGRAMS”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

This invention provides a business method that encompasses specific methods for the creation of secondary digital media programs (comprised of structured, rich metadata) by both professionals and consumers, collects and manages such programs via a comprehensive online database service, and makes them commercially available in numerous forms for use to any and all consumers and interested parties. The business method includes five novel characteristics, described herein.

“Data” is a term meaning “information” (the plural form of “datum”, meaning a single unit of information). “Metadata” is a term that essentially means “information about information”—that is, information which is descriptive of other information. In the business of digital media, especially as it pertains to commerce using computer networks (such as the Internet), metadata has particular value. For example, when a customer purchases a downloadable song file from an online music retailer, the metadata typically embedded in the song file include such detail as the names of the song, the artist, the album, the track number, and sometimes more. This metadata is simple and obvious, and of no special commercial value in and of itself.

The term “rich metadata” is often used to describe metadata which does have significant value. Examples of rich metadata in the case of a song might include the text of the song's lyrics, high-quality images, musical notation such as sheet music in digital form, tablature (a form of simplified music notation for stringed instruments), commentary, musicological analysis, links (URLs) to relevant resources stored on the Internet, and much more.

It is common for publishers and rights-holders of media works (audio and video) to provide rudimentary, simple metadata embedded in files sold for download, or streamed in real-time to terminal devices. It is extremely rare for such entities to provide any rich metadata, often due to the cost of producing it, or more often, because they simply don't have it, or don't have the legal right to distribute it.

Consumers of such media products and services however, often have great appreciation for rich metadata of many types, and are often willing and able to create it and to share it with others. This business method recognizes that these end-users (many of whom may also be professionals) are an untapped resource, capable of high-quality work, for which there exists a significant, underserved market.

Such rich metadata, based on a “primary program” such as a digital audio or video file, can be organized and structured to represent a “secondary program”. This secondary program is comprised of (potentially diverse) items of metadata, most often synchronized against the timing of the primary program. Each item of metadata can represent an “event”, which is the deployment of that item (such as via display on a video screen), at the precise instance in time when it has meaning in the context of the primary program. When the primary and secondary programs are played simultaneously, in synchrony, the secondary program enhances the experience for the consumer of the primary program, in meaningful ways. An easily understood example of a secondary program would be the metadata used to operate a Karaoke-style video display. In a typical Karaoke environment, a song is played over an audio playback system, while its lyrics are displayed on a video screen. Each individual lyric (word or whole line) is visually highlighted on the screen (such as via a color change), during the precise time that it should be sung. The individual lyric constitutes an event, represented by the text of the lyric, the timing of its beginning (relative to the start of the audio or video file), and the timing of its ending, and depending on implementation, zero or more additional technical details.

We use the term “secondary program”, therefore, to refer to a collection of (mostly synchronized) metadata-based events embodied in digital information, including associated time-synchronization data, in a structured sequence, associated with a single piece of primary media (audio or video).

Further, the metadata which makes up the secondary program can be organized into multiple “channels”, which can each serve a particular purpose. The consumer using the secondary program can configure the playback (or “rendering”) of the program such that only desired channels are deployed at a given time. In this way, the secondary program is different from the primary. The secondary program is configurable in an interactive fashion, and may be played back in different ways, including on different devices, or using different display aesthetics or graphical characteristics, subject to the consumer's preferences. Conversely, the primary program is linear, usually unchangeable, as in a typical digital audio or video file.

### Five Novel Characteristics of the Business Method:

First, the business method employs creation methods that are collaborative—that is, they facilitate the creation of secondary programs, each associated with a single media work (e.g. a song or video), by groups of one or more individuals. Members of such groups may or may not know each other, may be geographically separate, and may be anyone, from amateurs to media professionals. These diverse contributors can potentially be compensated for their efforts.

Second, the rich metadata is created in a multichannel form. That is, individual types of metadata can be associated with a specific channel of the associated media product. This is both analogous to and applicable to multichannel audio recordings. In such recordings, individual components of the final audio signal are stored discretely, and are individually addressable. As opposed to traditional monophonic or stereophonic recordings that offer no facility to separately modify component sounds in a musical work (such as individual musical instruments), multichannel recordings allow each channel (also called a “track”) to be discretely modified. For example, a multichannel recording of a rock band might have separate stereo or mono channels for drums, bass guitar, rhythm guitar, lead guitar, keyboards, lead vocals, and background vocals, each of which can be controlled independently of all the others. Such multichannel recordings of popular works are becoming increasingly available for sale.

Accordingly, the metadata created by the methods is also defined in terms of channels, each of which can be discretely created, modified, sold and distributed, as commercially appropriate. Such rich metadata channels may or may not be tightly associated with specific audio or video channels. The business method exploits the inherently multichannel characteristics of the secondary programs by facilitating transactions with a granularity of individual channels, not necessarily entire secondary programs.

Third, the digital “goods” upon which business method is based are the secondary media programs, which in and of themselves, as defined and described herein, are entirely novel. This synchronized metadata is the most valuable of all types, and is the most difficult to create, and to share. The business method reduces these difficulties, and creates a commercial market for the resulting assets.

Fourth, while the rich metadata can be literally embedded into the original digital media files if desired, this is not a requirement for it to be deployable. This is to the advantage of the business method, as it reduces the need for third-party business relationships. Instead, playback can take place in a (hardware or software) playback environment which can simultaneously deploy both unmodified original media files, and associated secondary program files, in discrete form, and which can synchronize the two so that all real-time events take place at the precisely correct times. This allows the secondary program to be treated as a distinct product, which may eliminate the need for business relationships between right-holders (or distributors) for original audio and video content, and unrelated owners or creators of secondary programs. Additionally, this allows the metadata to be independently deployed in conjunction with streaming media services. This would be possible, given a (presumably licensed) playback environment, implemented in either software or hardware, which could render both the secondary and the primary programs, in synchrony. In such case, the secondary programs would not necessarily need to be obtained from the streaming service provider.

Fifth, the business method anticipates that with a large volume of user-submitted metadata, quality control can become challenging. Accordingly, it provides a capability whereby the broad community of users can easily submit their assessments of the correctness of available metadata, which can be tabulated. Such tabulated information—the collective opinions of the large user base—can be used for many purposes, similarly to how “user reviews” are used on many web sites, whether for commerce or other purposes. In this case, the user reviews can serve as a basis for automated calculation of payments or other value, in an embodiment wherein metadata contributors may be compensated for their efforts.

Finally, the business method anticipates that some types of metadata might require licenses from media copyright owners to facilitate legal commerce, and other types will not. A key component of the online metadata database is the logic to distinguish between licensed and unlicensed assets, and to automate the compensation of licensors accordingly, based on relevant licensing agreements, or statutory requirements.

In summary, the invention is a novel business method which introduces the concept of secondary media programs, standardizes, cultivates, collects, and manages the collaborative creation of secondary media programs which are associated with specific digital audio or video products, using a novel multichannel data paradigm, for commercial exploitation, without requiring embedding in the original audio or video products.

### DESCRIPTION OF DRAWINGS OF INVENTION

### Brief Description of Figures:

The Applicant has attached the following figures of the invention at the end of this provisional patent application:

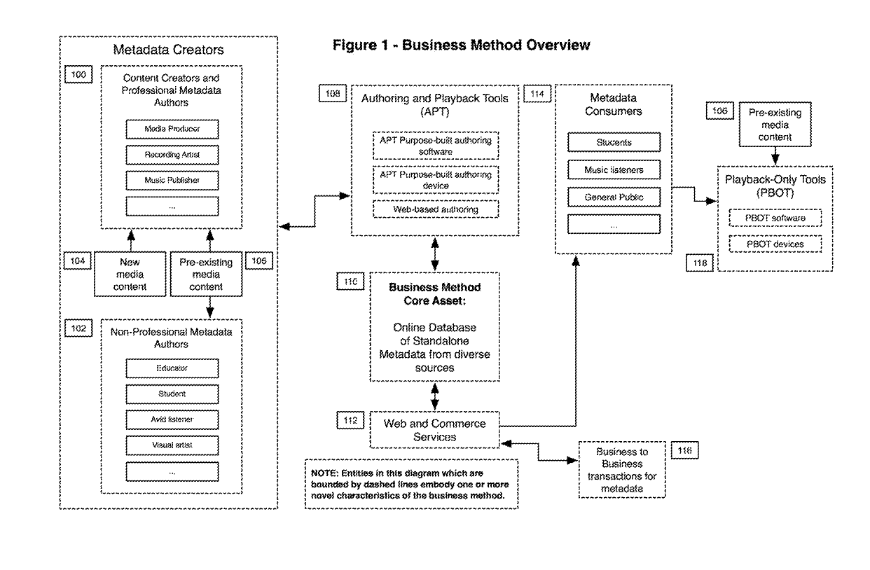

FIG. 1: Overview Of The Business Method

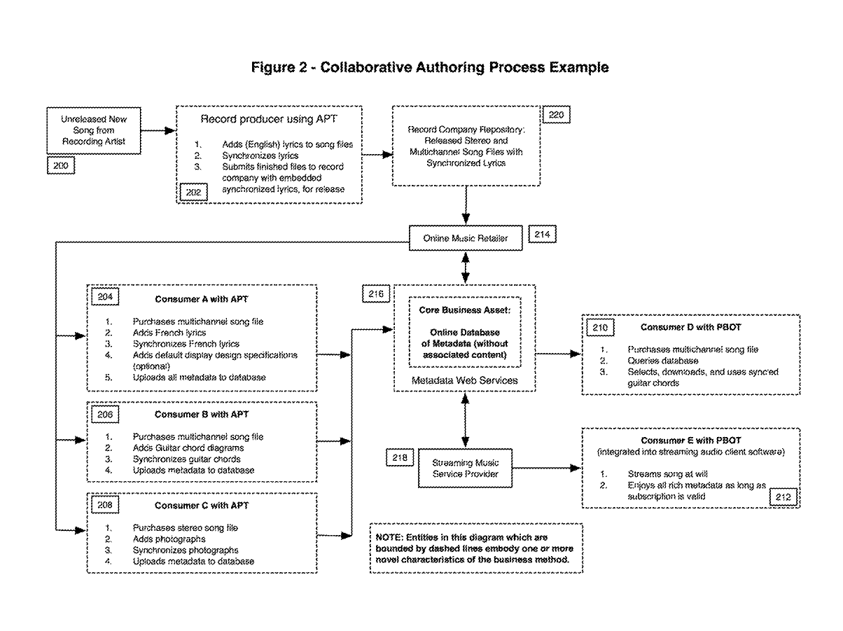

FIG. 2: Collaborative Authoring Process Example

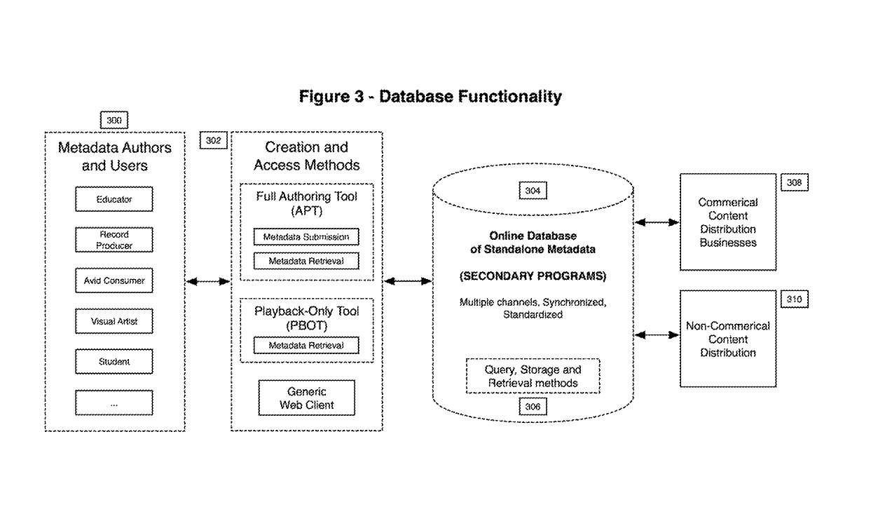

FIG. 3: Database Functionality

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

Identification of Parts/Components for Invention:

| Reference | |
|---|---|
| Numeral | Name of Component |
| 100 | Professional Metadata Creators |
| 102 | Non-Professional Metadata Creators |
| 104 | New Reference Media (audio or video - Primary Programs) |
| 106 | Existing Reference Media (audio or video - Primary |
| | Programs) |
| 108 | Authoring and Playback Tools (APT) |
| 110 | Database of Standalone Metadata (Secondary Programs) |
| 112 | Web and Commerce Services |
| 114 | Consumers of Metadata (Secondary Programs) |
| 116 | Business-to-Business Transactions |
| 118 | Playback-Only Tools (PBOT) |
| 200 | Unreleased (New) Media Content (Primary Programs) |
| 202 | Author: Record Producer |
| 204 | Author: Consumer A |
| 206 | Author: Consumer B |
| 208 | Author: Consumer C |
| 210 | Consumer D |
| 212 | Consumer E |
| 214 | Online Music Retailer (Downloads) |
| 216 | Database of Standalone Metadata (Secondary Programs, |
| | equal to 110) |
| 218 | Streaming Music Service Provider |
| 220 | Record Company Content Repository |
| 300 | Metadata Authors and Users |
| 302 | Creation and Access Methods (for Users) |
| 304 | Database of Standalone Metadata (Secondary Programs as |
| | 100, 216) |
| 306 | Database Query, Access and Retrieval |
| 308 | Commercial Content Distribution Businesses |
| 310 | Non-Commercial Content Distribution Businesses |

### Components of the Invention:

Professional 100 and Amateur 102 metadata creators: Fundamentally, the rich metadata that is the core asset of the business method is created by a certain population. These people are either professionals in media production industries, or are simply avid amateurs with some modest skills and a desire to create. The differences are minor: both segments of the population can and will create metadata using existing reference content 106 (already published and available), but generally speaking, professionals will be the only persons with access to new reference content 104 (prior to its release for sale), and will therefore have the first opportunity to create certain types of metadata. These are not rules however, and the distinction between amateurs and professionals can be blurred at times. It is possible that metadata authors of either type may be compensated monetarily or otherwise, for their contributions. Further, the business method recognizes that some professionals could be in the employ of a business entity implementing the method, for the primary purpose of populating the database.

Rich Metadata Authoring Tools 108 (APT): It is near-impossible to create rich metadata without appropriate authoring tools. The business method assumes the availability of one or more high-quality authoring tools, implemented in either software or hardware, and any business entity implementing the method will ensure that such tools are available, very likely by offering them itself. Omitting much detail, the characteristics of such tools include:

Low cost to both amateurs and professionals

Support for numerous types of rich metadata, and extensibility for new types

High-resolution synchronization capability for assigning real-time metadata events to specific points in reference media (primary program) time, including finely-controlled playback of primary programs, allowing rapid entry of events while the author is listening or viewing

Comprehensive editing capability

Simulation or playback capability, to review real-time performance during authoring

Flexible configuration logic for diverse target rendering environments

Compatible output formats for transfer of completed metadata to the online database, and for data exchange between authors (for collaboration)

In subsequent discussion, we will use the acronym APT (for Authoring and Playback Tool) to refer to this component of the business method.

Rich Metadata Playback Tools 108, 118: Use of rich metadata requires a suitable computing environment for deploying it. The business method assumes such capability in several forms:

Standalone metadata-centric media players 118: these will be implementations of devices and software that can simultaneously play separate and discrete files of original media content, and rich metadata, synchronously, without requiring them to be combined into a single file. They will also be able to play such combined files, when available. They will not however, have any authoring capability. In subsequent discussion, we will use the acronym PBOT (for Playback-Only Tool) to refer to this component.

Authoring tools with flexible playback capability 108 (APTs, also discussed above). As some form of synchronized playback is arguably essential to authoring (for testing purposes), it is expected that such tools will offer high-quality deployment as well as authoring capability. In many cases, a low cost authoring tool with good playback features will be the preferred environment for many consumers, most of the time, even if they may not be frequent creators.

NOTE: the terms “playback”, “deployment” and “rendering” (and sometimes “performance”) are essentially identical, in reference to secondary programs. Similarly, “secondary programs” and “metadata” or “rich metadata” are usually interchangeable.

Reference Media Content 104, 106: This is the (new 104 or existing 106) audio and video material on which the rich metadata is based. Most often, this will simply be discrete songs or musical works, stored in digital audio files in popular formats. This “content” is only a part of the business method in that its availability is assumed, and essential. Metadata authors acquire such reference content by any means, and use it as the basis of their own work, but it is not a part of the metadata. In fact, it is a critical point of the business method that the secondary programs can be managed distinctly from the reference content. The secondary programs can, in many cases, be added to the internal contents of a reference media file, but the business method does not require this in any way. Conversely, the secondary programs must contain a reliable identification datum of the reference media from which it was derived, but it need not contain the audio or video data itself. (This datum can be derived in numerous well-known ways.)

Online Database of Rich Metadata 110: This is the central asset which makes the business method viable. It is a dynamically organized collection of all metadata that is submitted by authors of any type. The database can be implemented monolithically, or it can be distributed or peered across a computer network. In the case of more than one business entity implementing the business method, more than one database might exist, and there might be distinctions between them, including entirely different contents.

Web Services and Commerce Engine 112: The database is the primary tangible asset of the business method, and Internet service and commerce protocols provide the functionality that makes the database valuable. That is, they govern the additions to and management of the individual metadata records in the database, make them accessible to client software applications, and perform financial transactions to enable commercial exploitation of the asset.

Metadata consumers 114: These are the consumers who acquire metadata from the database for their own use. The business method assumes that in some cases, there will be payments made for access to, or copying of, the metadata. The consumers might be individuals or organizations, amateurs or professionals, and they may transact on a wholesale or retail basis.

Other Businesses 116: While a main thrust of the invention is to empower and commercialize both the professional and voluntary work of interested individuals, there is a sizable business-to-business commercial opportunity as well. This includes, among others, existing and future online retailers and wholesalers of digital audio and video content, who can benefit in many ways from having access to the metadata database, and being able to offer its component assets to their customers. Importantly, it also includes streaming service providers, who can use the Commerce Services 112, to add value to their services by enriching the experience of the streaming customer, without significantly changing their own content repositories or infrastructure.

Monetization of the business method, while not depicted in the Figure, can be facilitated in several ways. These include but are not limited to: direct charges to consumers on a subscription or a-la-carte basis, indirect charges to consumers via third-party business arrangements, charges to third-party businesses for supply of secondary programs “in bulk”, advertising revenue from Web sites, and charges for APT or PBOT software, including both charges to consumers, and license fees to business entities adopting the PBOT for integration into other products.

### Operation of the Invention:

The business method can be viewed as a technique for cultivating and harvesting voluntary contributions to a large body of knowledge from a very diverse population, organizing it (thereby adding value to it), and making it available for commercial exploitation to an even larger body of interested consumers and businesses. This is best illustrated by description of a hypothetical scenario. We will trace the origin of rich metadata for a single piece of new media (a downloadable song file), before and after its release for commercial sale.

The example scenario is depicted in FIG. 2, and is explained in steps, of approximate chronological order. Numerals used are those of FIGS. 1 and 2, as necessary.

Step 1: A song 200 is recorded by an established music performer, to be released in both multichannel and traditional stereo audio formats, as downloadable files. Prior to its release, its producer 202 uses an APT 108 to enter synchronized lyrics (which are sung in English) for the song, thereby preparing it for use in a Karaoke environment. This constitutes a secondary program containing a single channel of metadata 216/110, created under the auspices of the original rights-owners, including the music publisher who owns the rights to those lyrics.

Step 2: The song is released for sale in both (Stereo and Multichannel) audio formats, each including embedded synchronized English lyrics, and becomes popular.

Step 3: Consumer A 204, who is fluent in French and English, buys a multichannel copy of the song. He carefully translates the lyrics into French, in a pleasantly singable way. He then uses an APT 108 to create a standalone metadata file containing the French lyrics to the songs, well-synchronized against the audio. This constitutes a secondary program containing a single channel of metadata. 216/110.

Step 4: He then uses the APT 108 to design a display configuration for the lyrics, which governs the aesthetics of how the synchronized lyrics will be displayed to subsequent users, (subject to constraints of their playback hardware). He chooses a font, colors for the various states of displayed text, and several background images of his own design, to appear under the lyrics during playback. When added to the French lyrics, this now constitutes a secondary program containing two channels of metadata 216/110.

Step 5: He uploads this file to the metadata database 216. (The uploaded metadata file contains an automatically generated identifier datum that indicates exactly which recording it is based on, but does not contain any audio.)

Step 6: A second consumer 206 purchases the original multichannel song file. This customer is a guitar instructor. He carefully analyzes the song and, determines the correct way to play the song's chords. He uses an APT 108 to represent the guitar music as rich metadata 216/110, in the form of visually displayed chord symbols, synchronized against audio much like the lyrics are synchronized for Karaoke. This constitutes a secondary program containing a single channel of metadata, which he then uploads to the database 216/110.

Step 7: A third consumer 208 is an avid amateur photographer. She purchases a copy of the stereo version of the song. She finds it to be evocative of some of her photographs, and decides to share that with other fans of the music. She uses an APT 108 to enter her photographs, and synchronizes their display to the music, in a slide show fashion. She chooses to embed actual copies of her photos into the metadata file, only in a small format, suitable for display on a smartphone, but not of high enough resolution to be pleasing on a large display. So she also adds, for each photo, a URL (Internet address), which links to a very high-quality large version of the image. (These larger versions will automatically be downloaded and deployed during end-user playback on larger devices with Internet connections, when possible.) This constitutes a secondary program containing a single channel of metadata, which she then uploads to the database 216/110.

Step 8: A fourth consumer 210 is an avid guitar student. He buys a copy of the multichannel version of the song. He notes the Karaoke-style lyrics display, but has little interest. Instead, he queries the database via a web interface, and discovers that other rich metadata is also available—in the form of the secondary program which is the superset of all of the metadata channels uploaded by the other consumers in the previous steps. He selects (only) the guitar chords, and downloads that for free. Using a PBOT 118, he plays back both the synchronized guitar chord display, and the original song (without combing them into a single file), until he learns the song.

Step 9: A fifth consumer 212 is a subscriber to an online streaming music provider 218. He does not download the song, but rather has access to it through the provider's client software application, so he can stream it to any of his compatible devices without ever owning a copy. Because the monthly cost of his streaming subscription includes full access to all the contents of the database 216/110, his client software informs him that he can use the French and English Karaoke lyrics, view the photos, and see the guitar chord display, whenever he streams the song. He has access to all the secondary programs because his streaming service provider 218 has a negotiated license agreement with (and pays fees to) the business entity controlling the database 216/110. The agreement does not allow the consumer to download permanent copies of the secondary programs (regardless of whether or not they are free of charge), but only to use them while he is a paying subscriber, deployed only within the streaming client application.

Database Functionality:

FIG. 3 illustrates the architectural purpose of the database of secondary programs.

Metadata Authors and Users 300 are the individuals who need access to the database. Their communications with the database 302 are typically implemented via an APT, a PBOT, or potentially, by a generic web browser interface or other custom software application. However, it can be assumed that APTs and PBOTs will have this database communication capability integrated in most cases.

The database itself 304, and the query, storage and retrieval methods 306 (as well as other communication and commerce protocols), are effectively the infrastructure of any business entity implementing the invention. The commercial viability of the business method is dependent on the richness of this asset, both in terms of high-quality secondary programs 304, and the robustness and completeness of the commerce services 306 it implements.

Content distribution services, both commercial 308 and non-commercial 310, are the business entities that require access to the database as well. Unlike individuals, however, their access is provided by the commerce services components of the database 306, instead of the APT or PBOT implementations.

### Alternative Embodiments

There is wide leeway in which the business method can be implemented, but several factors will be common to them all in order to be correctly qualified as instantiations of the method.

The primary asset of the business will be secondary media programs, comprised of sequenced rich metadata associated with individual primary works.

A large portion of the metadata may be contributed by amateurs.

The metadata will be organized in a discrete multichannel fashion.

The most highly valued metadata will be that which is deployed in real time, tightly synchronized to playback of the reference media (such as Karaoke lyrics and instructional music notation).

The database asset will be available via one or more computer networks, to a diverse and open clientele.

The business will not need to have copies of the reference primary media sources on which the metadata is based. Consumers and authors may obtain their own copies as necessary.

The metadata will be of consistent, standardized format, and differing authoring tools will be interoperable by virtue of the consistent data standards.

Authoring and playback tools may be implemented on any platform, and some may only be able to create subsets of the full range of possible metadata.

Creators of metadata can also be consumers of it, and collaboration among enthusiasts is facilitated and encouraged by the business method.

Copyrights are respected when applicable.

Commerce surrounding the metadata will be flexible, potentially encompassing payments to voluntary contributors as well as rights-holders and others.

Assessment of value of the metadata (for a variety of purposes) can be at least partly influenced by the opinions of the broad audience.

Alternative Uses:

The invention is a business method that facilitates commerce using a specific, novel type of valuable asset, in a particular way. The details of its implementation can be widely variable, but the essence of the method will be the same in all cases. It could be helpful however, to envision some of the diverse ways in which the business method can offer value to its clientele.

Professional Media Production: Creation of secondary programs to be supplied to customers purchasing digital audio or video products.

Arts, Entertainment, Recreation: Creation of secondary programs by end-users, for purposes of entertainment, communication, self-expression.

General Education: Creation of secondary programs that enhances the value of audio and video material as a general education medium.

Music Education: In particular, the invention enables numerous new methods of conveying musical information both for interactive voice and instrument training methods, and for musicological study. Of particular importance is the ability of the APT to serve as both an authoring and rendering environment. This, combined with a flexible audio playback architecture and display paradigm, makes it a unique and versatile learning and practice tool for musicians.

Languages: The ability to incorporate user-supplied language translations of textual material opens new opportunities for language students to experience new and compelling teaching methods.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. Apparatus comprising a storage medium storing a program having instructions which when executed by a processor will cause the processor to:
access data comprising a primary program generated using an authoring tool;
enable acceptance of a channel of a secondary program, each channel of the secondary program comprising a set of rich metadata associated with the primary program, from a user of the primary program other than an original creator of the primary program;
store the channel as a part of the secondary program in association with the primary program in a database of rich metadata for access by other users of the primary program; and
enable access, upon request, to the channel of the secondary program in conjunction with the primary program via a playback tool.

2. The apparatus of claim 1 wherein the instructions, when executed by the processor, will cause the processor to accept authorship information in conjunction with the channel.

3. The apparatus of claim 2 wherein the instructions, when executed by the processor, will cause the processor to, upon access to the channel, to credit an author identified by the authorship information with access to the secondary program.

4. The apparatus of claim 3 wherein the authorship information comprises information sufficient to affect payment to the author.

5. The apparatus of claim 4 wherein the instructions, when executed by the processor, will cause the processor to:
collect payment from an accessing user, accessing the channel; and
distribute the payment to the author.

6. The apparatus of claim 1 wherein the primary program comprises at least one of audio data and video data.

7. The apparatus of claim 6 wherein, when accessed using the playback tool, the channel is time synchronized with the primary program.

8. The apparatus of claim 1 wherein the secondary program is made up of multiple channels, each capable of playback independently of one another.

9. The apparatus of claim 8 wherein, when accessed using the playback tool and as directed by an accessing user, only the primary program and one of the multiple channels are accessed.

10. The apparatus of claim 1 further comprising:
a processor
a memory
wherein the processor and the memory comprise circuits and software for performing the instructions on the storage medium.

11. A method comprising:
accessing data comprising a primary program generated using an authoring tool;
enabling acceptance of a channel of a secondary program, each channel of the secondary program comprising a set of rich metadata associated with the primary program, from a user of the primary program other than an original creator of the primary program;
storing the channel as a part of the secondary program in association with the primary program in a database of rich metadata for access by other users of the primary program; and
enabling access, upon request, to the channel of the secondary program in conjunction with the primary program via a playback tool.

12. The method of claim 11 further comprising accepting authorship information in conjunction with the channel.

13. The method of claim 12 further comprising, upon access to the channel, crediting an author identified by the authorship information with access to the channel.

14. The method of claim 13 wherein the authorship information comprises information sufficient to affect payment to the author.

15. The method of claim 14 further comprising:
collecting payment from an accessing user, accessing the channel; and
distributing the payment to the author.

16. The method of claim 11 wherein the primary program comprises at least one of audio data and video data.

17. The method of claim 16 wherein, when accessed using the playback tool, the channel is time synchronized with the primary program.

18. The method of claim 11 wherein the secondary program is made up of multiple channels, each capable of playback independently of one another.

19. The method of claim 18 wherein, when accessed using the playback tool and as directed by an accessing user, only the primary program and one of the multiple channels are accessed.
